(19) United States
(12) Patent Application Publication
(10) Pub. No.: US 2026/0246771 A1
(43) Pub. Date: Aug. 20, 2026

(54) NETWORK ACCESS CONTROL FOR CLIENT DEVICES BASED ON FEATURE-BASED TOKENS

(71) Applicant: Starbucks Corporation, Seattle, WA (US)

(72) Inventors: Christopher D. Hemming, Bremerton, WA (US); Harish Krishnan, Redmond, WA (US); Anurag Kunchamwar, Renton, WA (US); Akhileshkumar Gopalakrishnan Nair, Black Diamond, WA (US); Roy Sam, Sunnyvale, TX (US); Maria D. Serbzhinskaya, Seattle, WA (US); Stephen J. Spates, Renton, WA (US)

(73) Assignee: Starbucks Corporation, Seattle, WA (US)

(21) Appl. No.: 19/289,737

(22) Filed: Aug. 4, 2025

Related U.S. Application Data
(60) Provisional application No. 63/759,604, filed on Feb. 18, 2025.

(51) Int. Cl. H04L 9/40

(52) U.S. Cl. CPC H04L 63/083; H04L 63/0227; H04L 63/20

(57) ABSTRACT

The network access level that is granted to a client device can be controlled based on feature-based tokens in some examples. In one such example, an authorization server system of a computer network can receive a request originating from a client device. In response to receiving the request, the authorization server system can retrieve a set of tokens from the request. The set of tokens may have previously been generated by a set of components in the computer network while propagating the request from the client device to the authorization server system. The authorization server system can then determine access rules by applying a predefined security policy to the features specified in the set of tokens. The authorization server system can control the client device's access within the computer network based on the determined access rules.

### GROSS-REFERENCE TO RELATED APPLICATIONS

This claims priority under 35 U.S.C. @ 119(e) to U.S. Provisional Patent Application No. 63/759,604, filed February 18, 2025 and titled "NETWORK ACCESS CONTROL FOR CLIENT DEVICES BASED ON FEATURE-BASED TOKENS," the entirety of which is hereby incorporated by reference herein.

### TECHNICAL FIELD

The present disclosure relates generally to computer security. More specifically, but not by way of limitation, this disclosure relates to controlling network access for client devices based on feature-based tokens.

### BACKGROUND

A client device can connect to a computer network to access one or more network resources. Before the client device is allowed to access the network, the client device may undergo an authentication process. During the authentication process, the client device may submit a username and password, a pin, or other authentication details to the computer network for evaluation. If the authentication details are correct, the client devices may be granted access the network.

Once the client device is granted access to the computer network, the network may execute an authorization process, which is separate from the authentication process. The authorization process can determine which access rules (e.g., permissions or restrictions) to apply to the client device to control the client device's level of access in the network. For example, the network may impose a security restriction on the client device that prevents it from accessing an unauthorized network resource, such as sensitive information. Different access rules may be applied to different client devices. For example, the computer network may grant an administrator's client device higher permissions than a normal user's client device, which allows the administrator to access more network resources than the normal user.

One common way of limiting a client device's access in a computer network is through rule-based access controls (RBAC). RBAC is security method that limits access to network resources based on a user's role. In an RBAC system, users are assigned to roles based on their job function and different permissions are assigned to each role. When a user logs in, their client device is granted the appropriate permissions for their role.

### BRIEF DESCRIPTION OF THE DRAWINGS

FIG. 1 shows a block diagram of an example of a system for implementing network-access control for client devices based on feature-based tokens according to some aspects of the present disclosure.

FIG. 2 shows an example of network devices in different layers of a computer network according to some aspects of the present disclosure.

FIG. 3 shows examples of a security policy and access rules according to some aspects of the present disclosure.

FIG. 4 shows a flowchart of an example of a process for generating feature- based tokens according to some aspects of the present disclosure.

FIG. 5 shows a flowchart of an example of a process for implementing network access control for client devices based on feature-based tokens according to some aspects of the present disclosure.

FIG. 6 shows a block diagram of an example of a computing device usable for implementing some aspects of the present disclosure.

### DETAILED DESCRIPTION

Traditional network access control systems, such as role-based access control (RBAC), are sufficient for small, static network environments with limited user groups. However, they can fail in large, dynamic networks. As the complexity of networks grows, traditional systems struggle to provide the granular and dynamic access rules required for modern environments. For example, in simpler scenarios with a small number of user groups, administrators can manually configure access rules by assigning permissions to predefined roles or groups. This process is relatively straightforward and manageable. However, as network environments grow in scale and complexity-often encompassing tens of thousands of client devices-these traditional approaches become increasingly impractical. In such large-scale networks, each client device may require a highly granular and dynamic set of access rules. Existing solutions lack the flexibility and scalability to handle this level of complexity. For instance, RBAC systems, which rely on predefined roles that assign a fixed set of permissions to users or devices based on their group membership, become untenable in scenarios where the sheer number of roles required to accommodate all possible combinations of permissions would lead to overwhelming administrative overhead, role explosion, and an unmanageable policy framework.

The limitations of existing solutions are further compounded by the increasing prevalence of heterogeneous and highly dynamic network environments, such as those found in Internet of Things (loT) deployments and hybrid cloud infrastructures. In these circumstances, the number of client devices connecting to the network can grow exponentially, and each device may have unique requirements for access and security. Traditional access control systems are simply not equipped to handle the demands of assigning and enforcing unique, context-aware permissions at this scale. Accordingly, there is a significant technical challenge in designing a network access control solution that can accommodate large-scale, highly granular, and dynamic environments. Without such advancements, existing solutions remain impractical, inefficient, and unworkable for modern, large-scale network ecosystems.

Some examples of the present disclosure can overcome one or more of the above technical challenges by employing a feature-based token system to control network access. Unlike traditional RBAC, which relies on static, predefined roles, this innovative approach leverages a distributed network architecture that dynamically evaluates each client device during the client device's interaction with components (e.g., hardware devices) of the network to identify relevant features and apply access rules based on the features.

More specifically, the client device can transmit a request to a computer network. The request can be a connection request, a data request, etc. In general, the client device may wish to access the network's resources. Examples of such network resources can include software, data (e.g., databases, database tables, or files), etc. Before being granted access to the network resources, the client device may need to undergo an authorization process facilitated by an authorization server system. This authorization process can happen after, and separately from, authenticating with the computer network using a set of credentials (e.g., username and password).

The client device's request can propagate through various components of the network before reaching the authorization server system to perform the authorization process. The components may be hardware components or software components. Examples of the components can include user interfaces, servers, Internet of Things (IOT) devices, backend services, and network devices such as routers, hubs, or firewalls. These components may form a connection pipeline through which the request is forwarded to the authorization server system. In some examples, the components may be in different technology layers of the computer network. For instance, the components may be in a user interface layer, a network layer, a firewall layer, and/or a service layer of the computer network.

As the request is forwarded to each component of the computer network, the component can determine one or more features associated with the client device, generate one or more tokens encapsulating the one or more features, and add the tokens to the request. For instance, when the request is transmitted through a network device such as a firewall, the network device can determine one or more features associated with the client device. The network device then generates a token that specifies the one or more determined features, and adds the token to the request as it progresses through the network.

When the request ultimately reaches the authorization server system, it has accumulated a set of tokens, each representing a specific feature or combination of features associated with the client device. The authorization server system retrieves this set of tokens from the request and evaluates it against a predefined security policy, which contains rules that define relationships between various features and corresponding access rules. Using these relationships, the authorization server system determines a tailored set of access rules for the client device based on the combination of tokens accumulated in the request.

Once the access rules have been determined for the client device, the authorization server system adds those access rules to the client device's session. The system then enforces those access rules, to control the client device's access to network resources, over the course of the session. This may involve setting permissions that specify which resources the client device can access, the level of access (e.g., read, write, execute), and any restrictions (e.g., time-based access limits or restrictions on sensitive data). This ensures that each client device operates within the custom security framework tailored to its associated features.

Through the above process, each client device is individually evaluated based on its associated features, allowing the system to apply access rules that are precisely tailored to the device's particular context. This feature-based token system provides a scalable, flexible, and highly granular solution for network access control. It addresses the limitations of existing systems by enabling the dynamic and context-aware assignment of access rules to a large and diverse set of client devices. This not only enhances network security and efficiency, but also makes the system easy to deploy and maintain, even in the most complex and demanding network environments. For example, the feature-based token system allows for a high level of granularity in access control, enabling the system to generate and enforce thousands-or even tens of thousands-of unique combinations of permissions for client devices. Additionally, because the process of generating tokens and applying access rules is automated, it requires minimal manual intervention from network administrators. This reduces administrative overhead while also minimizing the risk of human error, such as misconfigurations or inconsistent policy enforcement.

As one specific example, a service executing on a client device may need to access a computer network to perform a function. To that end, the service may transmit a request to the computer network that initiates a session. The request can include a credential collection. The service may attach its Java Web Token (JWT) to the credential collection in the request. Because the service is executing on a client device located at a store, the store's token can be appended to the credential collection in the request. Because the user is logged in, a user token can be generated and appended to the credential collection. As the request passes through a firewall of the computer network, an additional token can be appended to the credential collection to signify that the request is coming through the firewall. Because the firewall is in North America, the firewall can also append a token to the credential collection in the request to signify that the client device is connecting from North America. The computer network eventually forwards the request with the credential collection to an authentication server system, which may or may not be separate from the authorization server system. Once at the authentication server system, an additional token can be appended to the credential collection to signify that the user is an administrator of the system. One final token can be appended to the credential collection because the store has a specific feature, like "Batch Bake" or "Scanless Payment" enabled. The final token set in the credential collection is then used by the authorization server system to create a set of access rules for the session. The set of access rules is then applied to the session to limit network access for the service accordingly.

These illustrative examples are given to introduce the reader to the general subject matter discussed here and are not intended to limit the scope of the disclosed concepts. The following sections describe various additional features and examples with reference to the drawings in which like numerals indicate like elements but, like the illustrative examples, should not be used to limit the present disclosure.

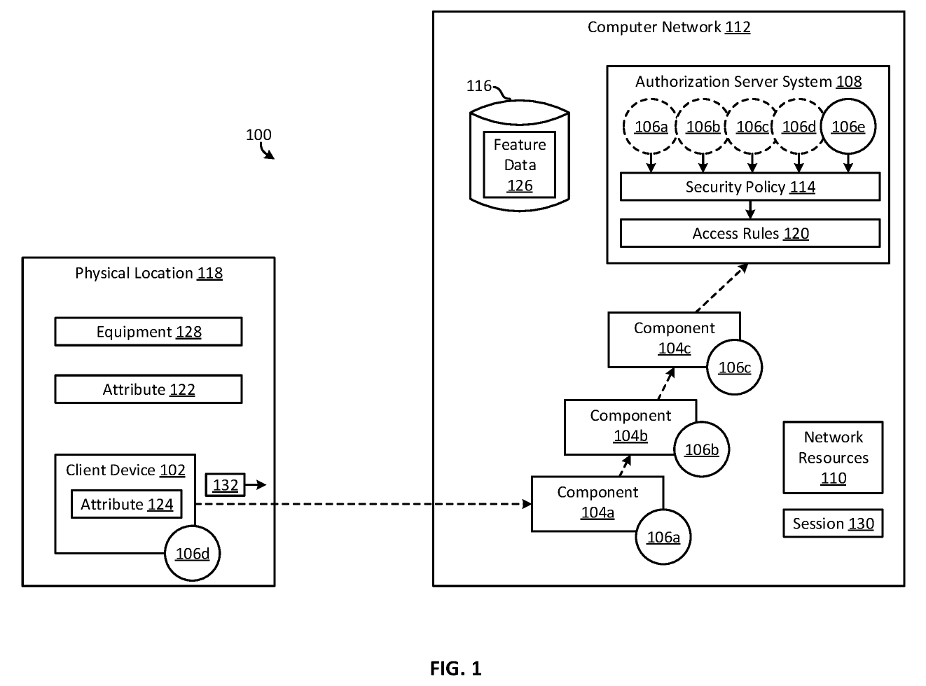

FIG. 1 shows a block diagram of an example of a system 100 for implementing network-access control for client devices based on feature-based tokens according to some aspects of the present disclosure. The system 100 includes a client device 102, such as a laptop computer, desktop computer, tablet, mobile phone, server, point-of-sale terminal, or kiosk. The client device 102 can be present at a physical location 118. The physical location 118 may include a building, such as a store, restaurant, cafe, school, house, or office building. The physical location 118 may include a drive-through, in some examples. The client device 102 can be located inside or outside the building, at the drive-through, or elsewhere at the physical location 118.

The client device 102 can transmit a request 132, for example to access network resources 110 of the computer network 112. Examples of such network resources can include applications; services such as microservices or serverless functions; stored data such as files or database entries; or any combination of these. For instance, the client device 102 may be configured to transmit requests 132 to backend services of the computer network 112 that help facilitate an order function, a payment function, etc. Additionally or alternatively, the client device 102 may be configured to transmit requests 132 for data from the computer network 112 to perform said functions. However, before being granted permission to access the network resources 110, the client device 102 may need to undergo an authentication process with an authentication server system. After authenticating with the authentication server system, the client device 102 can also undergo an authorization process with an authorization server system 108, which may be the same as or different from the authentication server system. In this context, "authentication" refers to determining who a user is, while "authorization" refers to determining what a user can access. The authorization server system 108 include one or more physical servers configured to perform authorization processes.

Before reaching the authorization server system 108, the request 132 may be transmitted through one or more intermediary components 104a-c of the computer network 112. Examples of the intermediary components 104a-c can include network devices (e.g., hubs, routers, switches, or firewalls), user interfaces, services, or any combination of these. The request 132 may be transmitted to the intermediary components 104a-c in series or in parallel to one another. For instance, the request 132 may be transmitted through the components 104a-c in the sequence shown by the dashed arrows in FIG. 1 -first component 104a, then component 104b, then component 104c. In other examples, the request 132 may be transmitted to more or fewer components in sequence or in parallel. The intermediary components 104a-c can serve as a connection pipeline through which the request 132 propagates before reaching the authorization server system 108.

The components 104a-c may be located in the same or different technology layers of the computer network 112. A technology layer is a specific level within a network architecture that has a set of protocols and/or technologies designed to work together to perform a particular function. In some examples, the technology layers can correspond to the seven distinct layers of the Open Systems Interconnection (OSI) model: physical, data link, network, transport, session, presentation, and application. Each technology layer has a specific role. For example, the physical layer can handle electrical signals on the wire, the data link layer can manage error detection on a local network, and the network layer can determine the best route for data packets across multiple networks. Other arrangements of technology layers are also possible. For example, the computer network 112 can include a user interface layer, a network layer, a firewall layer, and/or a service layer. The user interface layer can provide user interfaces (e.g., graphical user interfaces) to client devices, the network layer can provide packet routing, the firewall layer can provide firewall/security protection, and the service layer can provide applications and services (e.g., microservices) with functionality that can be requested by the client device.

The intermediary components 104a-c may each have their own respective primary functionality. For example, the primary function of the intermediary component 104a may be to provide graphical user interfaces to the client devices. The primary purpose of the intermediary component 104b may be to provide packet routing. The primary purpose of the intermediary component 104c may be to provide a firewall or other packet monitoring. But in some examples, the intermediary components 104a-c can be modified to perform the secondary function of adding tokens 106a-c to the session 130, as explained below.

When the request 132 reaches each of the intermediary components 104a-c, the intermediary component can generate a respective token (e.g., tokens 106a- c). The token may be a JavaScript Object Notation (JSON) token, a client certificate, a custom token, or another type of token. The token can specify at least one feature associated with the client device 102 from which the request 132 originated.

In some examples, a feature can be an attribute 124 of the client device 102 itself, such as its type, hardware configuration, or software characteristics. In other examples, a feature can be an attribute 122 of the client device's physical location 118, which can provide contextual information about the operating conditions of the client device 102. For instance, the feature can be a weather condition present at the client device's 102 physical location 118. The weather condition may include the temperature, humidity level, wind speed, wind direction, and/or precipitation (e.g., sunny, rainy, or snowy) at the physical location. In some examples, the feature can be an attribute 122 of a building or other structure in proximity to the client device 102. Examples of such attributes may include the specific identity or designation of the building associated with the client device 102, the precise physical location 118 or address of the building, the type or classification of the building (e.g., a drive-thru location, an express service facility, or a traditional dine-in establishment), the building's specific equipment 128, and/or software executing on one or more other computing devices at the building. The equipment 128 may include, for example, a particular type of roaster, heater, oven, refrigeration unit, and/or other appliance or machinery present at the building. These features can provide useful information about the client device 102 and its surrounding environment, which can make them valuable in determining which access rules to apply to the client device 102. Each individual token (e.g., token 106a) may specify one or more features of the client device 102.

The intermediary components 104a-c can determine the features associated with the client device 102 in any number of ways. For example, the intermediary components 104a-c can determine the features by communicating with the client device 102. For instance, the client device 102 can transmit information to the intermediary component 104a, which can use the information to determine a feature. As another example, the intermediary components 104a-c can determine the features by communicating with one or more other devices at the physical location 118, such as sensors or equipment 128 at the physical location 118. As still another example, the intermediary components 104a-c can determine the features by communicating with one or more remote data sources external to the computer network 112, such as remote databases or services. As yet another example, the intermediary components 104a-c can determine the features by referencing stored feature data 126. The feature data 126 may be stored in a database system 116, which may be queried to retrieve the feature data 126.

As one illustrative example, the intermediary component 104a can determine a physical location 118 of the client device 102 based on an IP address of the client device 102, a global positioning system (GPS) location provided by the client device 102, or another location identifier provided by the client device 102. As another example, the intermediary component 104a can determine the equipment 128 at the physical location 118 based on the stored feature data 126, which may include mappings of physical locations to equipment. The intermediary component 104a may first determine the physical location 118 of the client device 102 and then use the mapping to determine which equipment 128 is present at the physical location 118. As another example, the intermediary component 104a can determine the equipment 128 at the physical location 118 by communicating with that equipment 128, which may be network connected. As another example, the intermediary component 104a can determine one or more weather conditions at the physical location 118 by accessing a remote weather service system via an application programming interface (API). As still another example, the intermediary component 104a can determine the hardware, software, and/or type of the client device 102 by receiving that information from the client device 102. As another example, the intermediary component 104a can determine a building type associated with the client device 102 based on a building type identifier provided by the client device 102. The client device 102 may be preprogrammed to provide the building type identifier to the intermediary component 104a. As yet another example, the stored feature data 126 may map physical locations to building types at said locations. The intermediary component 104a may thus use the stored feature data 126 to determine a building type at the physical location 118, after determining that the physical location 118 corresponds to the client device 102. Any one or more of these techniques may be used by any one or more of the intermediary components 104a-c to determine one or more features associated with the client device.

After each of the tokens 106a-c is generated, it can be added to the request 132. For example, the intermediary components 104a-c can generate the tokens 106a-c, respectively, and add them to a header of the request 132. That way, the tokens 106a-c travel with the request 132 as it propagates through the computer network 112.

In some examples, the client device 102 can also generate one or more tokens, such as token 106d, specifying one or more associated features. The client device 102 can add the tokens to the request 132, before the request 132 is initially transmitted to the computer network 112. That way, the request 132 can have a starting set of tokens generated by the client device 102 based on its own knowledge.

Eventually, the request 132 will reach the authorization server system 108. The authorization server system 108 can extract the tokens 106a-d from the request 132. In some examples, the authorization server system 108 may itself generate one or more tokens 106e that specify one or more features associated with the client device 102 and add these tokens to the collection of tokens associated with the request 132. The authorization server system 108 can then apply a security policy 114 to the features in the tokens 106a-e to determine access rules 120 to apply to the client device 102 (e.g., its session 130) in the computer network 112.

The security policy 114 is a predefined set of rules that correlates client device features to permissions and/or restrictions in the computer network 112. For instance, the security policy 114 can have rules that assign different permissions and/or restrictions in the computer network 112 to different physical locations, building types, equipment configurations, and/or weather conditions. By applying the security policy 114 to the particular combination of features specified in the tokens 106a-e, the authorization server system 108 can generate a customized combination of access rules 120 (permissions and/or restrictions) tailored to the client device's specific feature set.

Once the access rules for the client device 102 have been determined, the authorization server system 108 can apply the access rules 120 to the session 130 to ensure continuity of the access rules 120 throughout the session 130. The computer network 112 can use the access rules 120 to control (e.g., restrict) the client device's access in the computer network 112 for the duration of the session 130. This may involve interfacing with one or more security mechanisms in the computer network 112. For example, based on the access rules 120, the computer network 112 may apply an access restriction to a database system 116 that prevents the client device 102 from access certain data, such as personally identifiable information (PII).

Through the above process, the system 100 can dynamically tailor the network access rules for the client device's 102 based on its particular combination of features, such as the attributes of the client device 102 and/or its surrounding environment. This dynamic process can occur in real-time, as the client device 102 attempts to access the network resources 110, based on its particular combination of features at that specific point in time. If the client device's associated features change over time, each time it connects to the computer network 112 and/or starts a new session, the client device 102 may be dynamically assigned a different set of access rules to account for those changes. This can provide a robust, flexible, and extensible security framework for client devices.

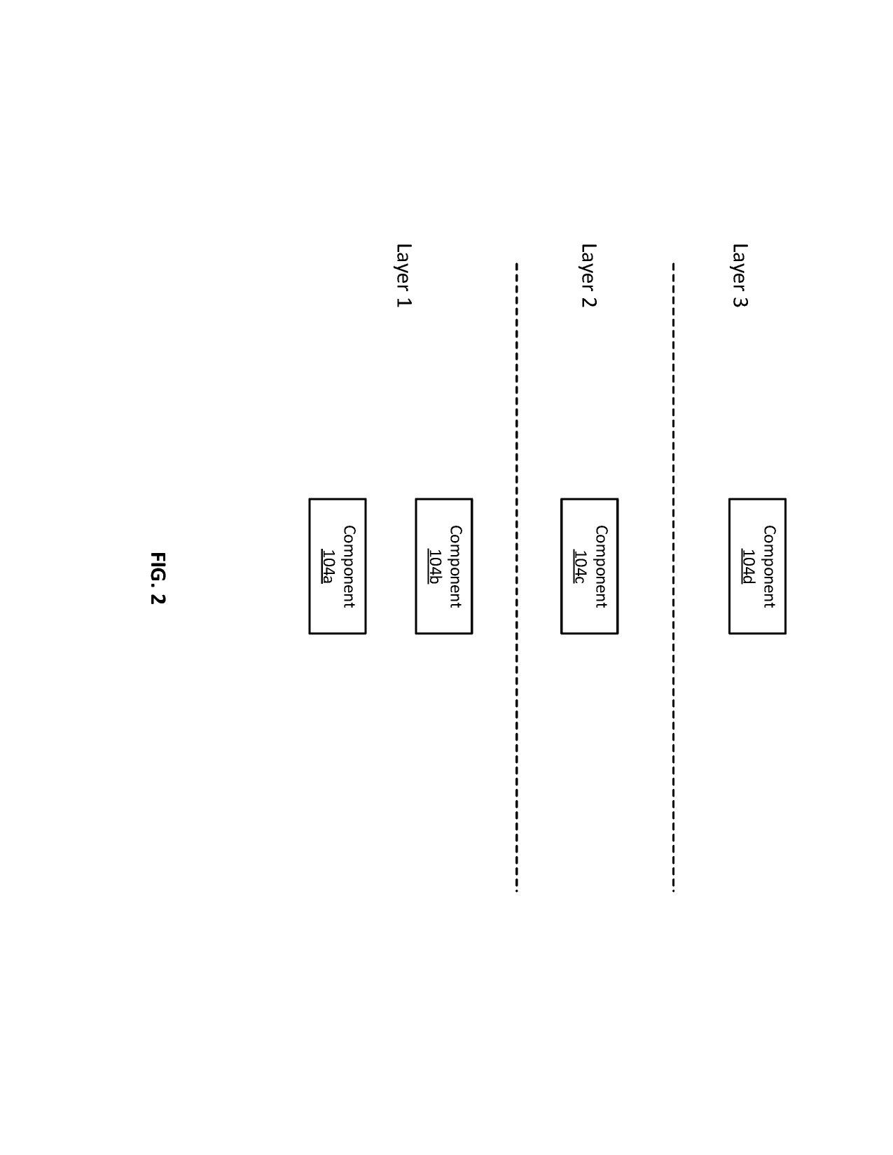

Turning now to FIG. 2, shown is an example of components in different technology layers of a computer network according to some aspects of the present disclosure. In this example, components 104a-b may be user interface components in a first technology layer of the computer network. Component 104c may be a firewall component in a second technology layer of the computer network. Component 104d may be an authorization server in a third technology layer of the computer network. Of course, other examples may involve any number of components in any number and arrangement of technology layers.

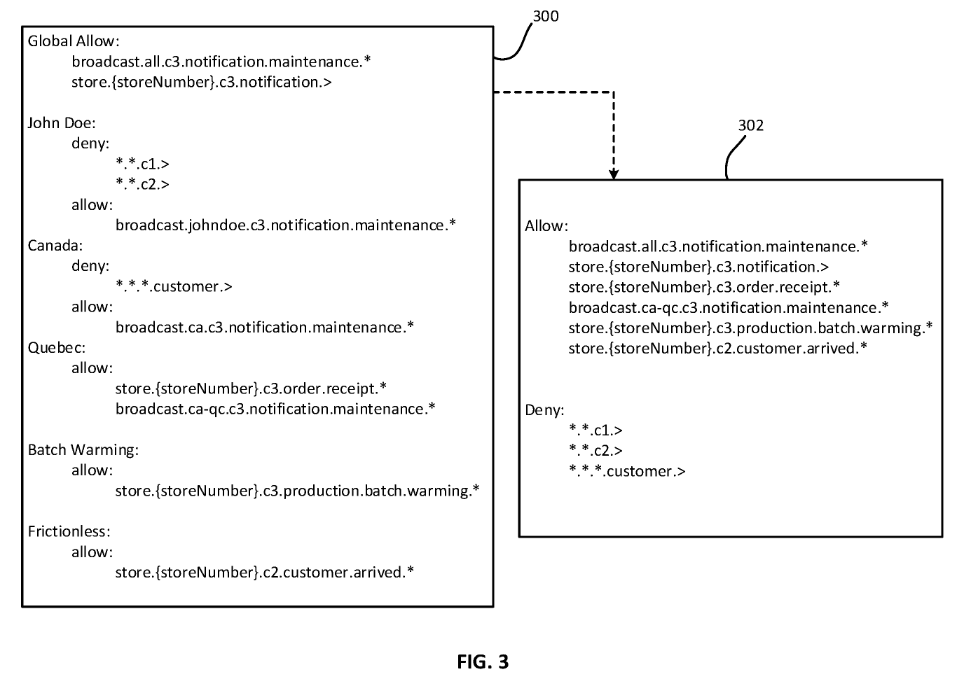

Turning now to FIG. 3, shown are examples of a security policy 300 and access rules 302 according to some aspects of the present disclosure. As shown, the security policy 300 has rules to allow or deny access to certain network endpoints based on various features, such as a name (e.g., "John Doe"), one or more geographical regions (e.g., Canada and Quebec), one or more pieces of equipment (e.g., a batch warming oven), and/or whether certain functionality (e.g., frictionless payments) is enabled. The security policy 300 can also have certain global allowances or denials, which apply to most or all client devices.

In this example, the client device can be associated with a physical location that is in Quebec, Montana. The physical location can have a batch warming oven and frictionless payments enabled. The client device may be associated with the name Jane Doe. These features may be determined by intermediary devices and stored in tokens. Upon evaluating the tokens, the authorization server system can determine the access rules 302. The access rules 302 allow access to the network endpoints associated with global allowance, Quebec, Batch Warming, and Frictionless, but deny access to the endpoints associated with Canada and John Doe. The network endpoints may include variable values, such as a store number ("StoreNumber"), that may be populated with feature data. In other examples, a different client device with a different set of associated features may be assigned different access rules based on the security policy 300.

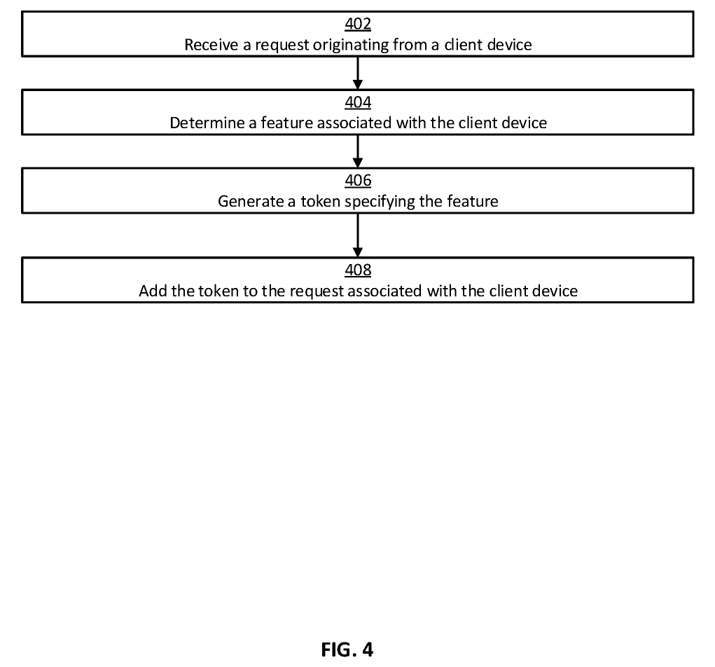

Turning now to FIG. 4, shown is a flowchart of an example of a process for generating feature-based tokens according to some aspects of the present disclosure. Other examples may involve more operations, fewer operations, different operations, or a different order of operations than is shown. The operations of FIG. 4 are described below with respect to the components of FIG. 1 described above.

In block 402, a component of a computer network 112 receives a request 132 originating from a client device 102. In some examples, the component may be an intermediary component 104, an authentication server system, or an authorization server system 108. Such an intermediary component 104 may be physically and/or logically positioned between the client device 102 and the authorization server system 108, in some examples.

In block 404, the component determines a feature associated with the client device 102. The component can determine the feature associated with the client device 102 based on information, which may be provided by the client device 102. The information may identify the client device 102, a geographical location of the client device 102, a store or other building associated with the client device 102, etc. The feature may be an attribute 124 of the client device 102 itself or an attribute 122 of an associated physical location 118. In some examples, the component can determine multiple features associated with the client device 102 based on the information.

In block 406, the component generates a token (e.g., token 106a) specifying the one or more features determined in block 404. In some examples, the component can generate multiple tokens, with each token specifying one or more of the determined features. The token may be formatted as a JSON token, a certificate, etc.

In block 408, the component adds the token to the request 132 associated with the client device 102. For example, the component can add the token to a credential collection associated with the request 132. The credential collection may be included in a header of the request 132, which may have originated from the client device 102 and propagated through the computer network 112 to the component.

The above process may be performed in sequence or in parallel by multiple components of the computer network 112. As a result, multiple tokens may be added to the request 132 in real time, e.g., as the client device 102 is connected to the computer network 112. The tokens can be added to the request 132 before it reaches the authorization server system 108.

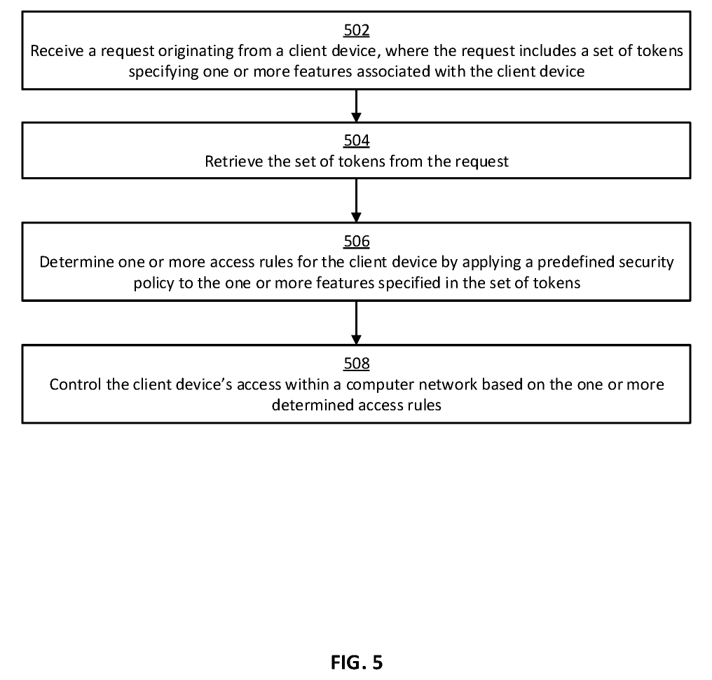

Turning now to FIG. 5, shown is a flowchart of an example of a process for implementing network access control for client devices based on feature-based tokens according to some aspects of the present disclosure. Other examples may involve more operations, fewer operations, different operations, or a different order of operations than is shown. The operations of FIG. 5 are described below with respect to the components of FIG. 1 described above.

In block 502, an authorization server system 108 receives a request (e.g., a connection request, a request for data, or a request to execute a service) originating from a client device 102. The request 132 may propagate through various other components in a computer network 112 before finally arriving at the authorization server system 108. The request 132 can include a set of tokens (e.g., tokens 106a-d), which may consist of one or more tokens. The one or more tokens can specify one or more features associated with the client device 102. The features can include attributes 124 the client device 102 itself, attributes 122 of its physical location 118, or attributes of a building containing the client device 102

Some or all of the tokens may have been generated after the client device 102 connected to the computer network 112. For example, the components 104a-c of the computer network 112 may have generated the set of tokens after the client device 102 initially connected to the computer network 112 and/or established the session 130. In some such examples, the components 104a-c may have generated the set of tokens in real time as the request 132 passes through them on its way to the authorization server system 108. In some examples, the client device 102 may have generated and added a token 106d to the request 132 before transmitting the request 132 to the computer network 112.

In block 504, the authorization server system 108 retrieves the set of tokens from the request 132. For example, the authorization server system 108 can extract the set of tokens from a header of the request 132.

In block 508, the authorization server system 108 determines one or more access rules 120 for the client device 102 by applying a predefined security policy 114 to the one or more features specified in the set of tokens. For example, the security policy 114 can include logic statements or other rules that are applied to the features to determine permissions and restrictions for the client device 102 in the computer network 112.

In block 510, the authorization server system 108 controls the client device's access within the computer network 112 based on the one or more determined access rules 120. For example, the authorization server system 108 can limit the client device's access within the computer network 112 to the specific permissions and restrictions associated with the access rules 120. This may involve communicating with one or more other devices in the computer network 112, for example to institute RBAC controls, network firewall controls, database-level access controls, etc., in accordance with the access rules 120.

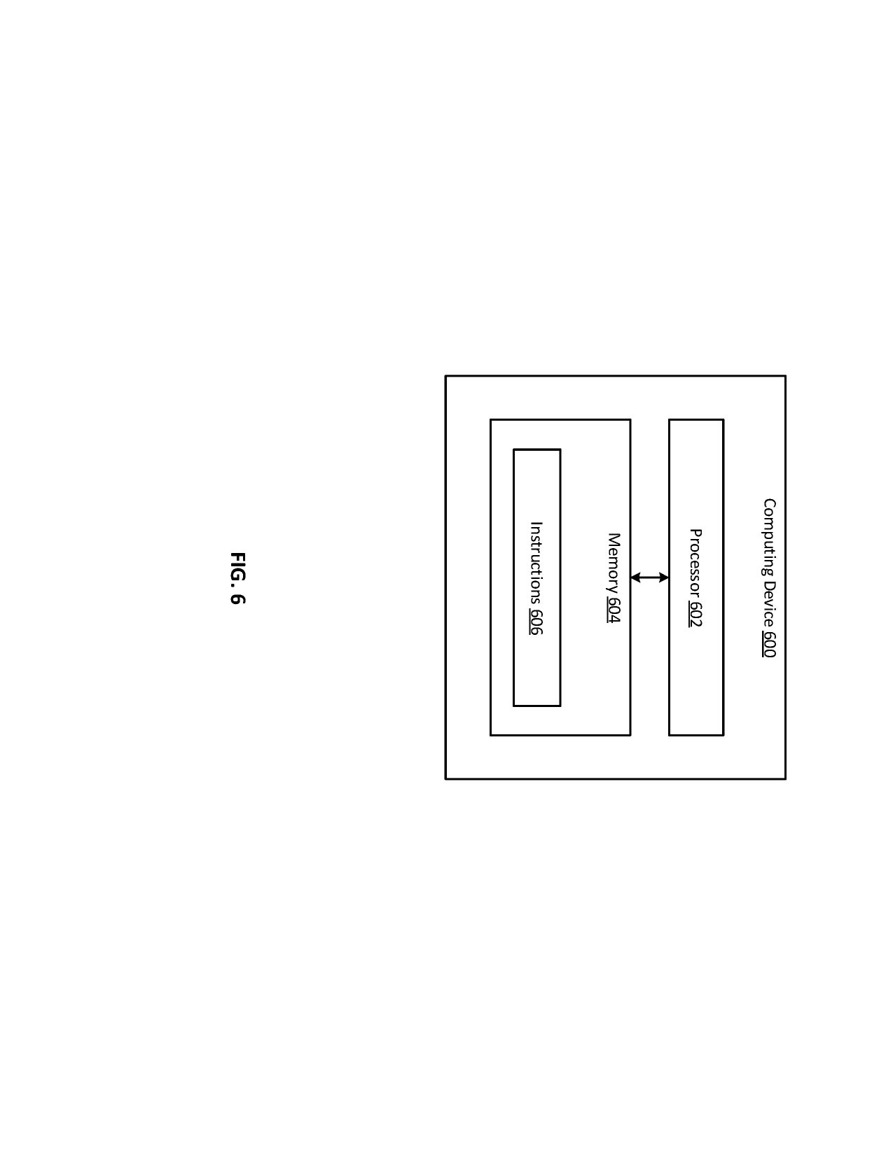

Turning now to FIG. 6, shown is a block diagram of an example of a computing device 600 usable for implementing some aspects of the present disclosure. In some examples, the computing device 600 may correspond to the client device 102, the authorization server system 108, or any of the intermediary components 104a-c of FIG. 1.

The computing device 600 includes a processor 602 communicatively coupled to a memory 604 by a bus. The processor 602 can include one processor or multiple processors. Examples of the processor 602 can include a Field-Programmable Gate Array (FPGA), an application-specific integrated circuit (ASIC), or a microprocessor. The processor 602 can execute instructions 606 stored in the memory 604 to perform operations. The instructions 606 may include processor-specific instructions generated by a compiler or an interpreter from code written in any suitable computer-programming language, such as C, C++, C#, Java, or Python.

The memory 604 can include one memory device or multiple memory devices. The memory 604 can be volatile or non-volatile (e.g., it can retain stored information when powered off). Examples of the memory 604 include electrically erasable and programmable read-only memory (EEPROM), flash memory, or cache memory. At least some of the memory 604 includes a non-transitory computer-readable medium from which the processor 602 can read instructions 606. A computer-readable medium can include electronic, optical, magnetic, or other storage devices capable of providing the processor 602 with the instructions 606 or other program code. Examples of a computer- readable mediums include magnetic disks, memory chips, ROM, random-access memory (RAM), an ASIC, a configured processor, and optical storage.

The computing device 600 can also include input components. One example of an input component can include a user input device, which may include one user input device or multiple user input devices. Examples of such user input devices can include a mouse, a keyboard, a touchpad, and a touch-screen display. Another example of an input component can include one or more sensors, such as a global positioning system (GPS) unit, a gyroscope, an accelerometer, an inclinometer, and/or a camera.

The computing device 600 can further include output components. One example of an output component can include a display, which may include one display or multiple displays. Examples of such displays can include a liquid crystal display (LCD) or a light-emitting diode (LED) display. The computing device 600 may also include an audio output component such as a speaker, a haptic output component such as a haptic actuator, or another type of output component.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure. For instance, some examples described herein can be combined with other examples to yield further examples.

1. A system comprising: a set of components configured to propagate a request from a client device to an authorization server system, wherein each of the components is configured to:
receive the request;
determine a respective feature associated with the client device;
generate a respective token indicating the respective feature associated with the client device; and
add the respective token to the request; and
the authorization server system, wherein the authorization server system is configured to:
receive the request, the request including a set of tokens, the set of tokens including each respective token added to the request by the set of components, and the set of tokens specifying a plurality of features associated with the client device;
in response to receiving the request, retrieve the set of tokens from the request;
determine one or more access rules for the client device by applying a predefined security policy to the plurality of features specified in the retrieved set of tokens; and
client device's access within a computer network based on the one or more determined access rules.

2. The system of claim 1, wherein the one or more access rules include a permission to access a network location, and wherein the client device is granted access to the network location based on the permission.

3. The system of claim 1, wherein the one or more access rules include a restriction against accessing a network location, and wherein the client device is denied access to the network location based on the restriction.

4. The system of claim 1, wherein the plurality of features include a unique identifier of a building associated with the client device, a geographical location of the building, a type of the building, and a piece of physical equipment in the building.

5. The system of claim 1, wherein the authorization server system is configured to control the client device's access within the computer network by interfacing with one or more security mechanisms of the computer network.

6. The system of claim 1, wherein the set of components include a firewall.

7. The system of claim 1, wherein the set of components include at least two network devices in different technology layers of the computer network.

8. The system of claim 1, wherein the components are configured to sequentially add the respective tokens to the request as the request sequentially propagates through the components.

9. The system of claim 8, wherein the components establish a communication pipeline from the client device to the authorization server system through which the request is propagated.

10. The system of claim 1, wherein at least one token in the set of tokens is provided by the client device.

11. The system of claim 1, wherein at least one component in the set of components is configured to determine the respective feature by querying a database that is external to the at least one component.

12. A method comprising:
receiving, by a processor of a computer network, a request originating from a client device,
in response to receiving the request, retrieving, by the processor, a set of tokens from the request, the set of tokens specifying a plurality of features associated with the client device, wherein the set of tokens were generated and added to the request by a set of components in the computer network while propagating the request from the client device to an authorization server system;
determining, by the processor, one or more access rules for the client device by applying a predefined security policy to the plurality of features specified in the retrieved set of tokens; and
controlling the client device's access within the computer network based on the one or more determined access rules.

13. The method of claim 12, wherein the plurality of features include a geographical location of a building, a type of the building, or a piece of physical equipment in the building.

14. The method of claim 12, wherein the plurality of features include a software program executing on a computing device that is different than the client device.

15. The method of claim 12, wherein the set of components include a firewall.

16. The method of claim 12, wherein the set of components include at least two components in different technology layers of the computer network.

17. The method of claim 12, wherein the set of components sequentially add the respective tokens to the request in an order in which the request propagates through the set of components to the authorization server system.

18. The method of claim 12, wherein at least one component in the set of components generates at least one token in the set of tokens by communicating with a computing device other than the client device, wherein the computing device is positioned at a physical location associated with the client device.

19. The method of claim 12, wherein at least one token in the set of tokens is generated by the client device.

20. A non-transitory computer-readable medium comprising program code that is executable by one or more processors for causing the one or more processors to perform operations including:
receiving a request originating from a client device;
in response to receiving the request, retrieving a set of tokens from the request, the set of tokens specifying a plurality of features associated with the client device, wherein the set of tokens were generated and added to the request by a set of components in a computer network while propagating the request from the client device to an authorization server system;
determining one or more access rules for the client device by applying a predefined security policy to the plurality of features specified in the retrieved set of tokens; and
controlling the client device's access within the computer network based on the one or more determined access rules.
